(19) United States
(12) Patent Application Publication
(10) Pub. No.: US 2026/0355989 A1
(43) Pub. Date: Nov. 12, 2026

(54) TAPE CUTTING TOOL

(71) Applicant: Westco Fine Finishing, Belville, NC (US)

(72) Inventors: Jeffrey M. West, Belville, NC (US); Dino Kouros, Burr Ridge, IL (US)

(21) Appl. No.: 19/670,869

(22) Filed: May 7, 2026

Related U.S. Application Data
(60) Provisional application No. 63/801,450, filed on May 7, 2025.

(51) Int. Cl. B26B 5/00

(52) U.S. Cl. CPC B26B 5/005

(57) ABSTRACT

A tape cutting tool has a body, a first contact surface on the body, a second contact surface on the body oriented so as not to be parallel with the first contact surface, and a cutting blade held by the body. The cutting blade protrudes from the second contact surface and is spaced at a predetermined distance from the first contact surface. The contact surfaces can bear against surfaces of an object that is masked off to be painted and can precisely guide the cutting blade to cut the tape to yield a straight tape line.

### RELATED APPLICATION DATA

This patent is entitled to the benefit of and claims priority to co-pending U.S. Provisional Application Ser. No. 63/801,450 filed May 7, 2025, and entitled “Tape Cutting Tool.” The entire contents of this prior filed application are hereby incorporated herein by reference.

### BACKGROUND

### 1. Field of the Disclosure

The present disclosure is generally directed to painting and surface preparation tools, and more specifically to a tape cutting tool that is designed to improve efficiency and precision for applying masking or painter's tape to objects to be painted.

### 2. Description of Related Art

When painting objects, painter's tape or masking tape is often applied to mask off surfaces or surface portions that are not to be painted while painting of surfaces or surface portions adjacent the tape. The tape is typically applied by hand with one edge of the tape adjacent to the surface to be painted. This edge defines a line between the painted surface or surface portion and the unpainted surface or portion. Manual application of the tape can be very time consuming and laborious when the goal is to achieve straight or precise lines.

In one example of an object to be painted, the front facing edges of European-style or frameless cabinets are painted while the interior of the cabinet may not be painted in the same color or manner. Thus, painter's tape or masking tape is typically applied to the inside cabinet surfaces adjacent the cabinet front opening, leaving the front facing edges of the cabinet exposed for painting. Applying the tape manually is difficult and time consuming and still typically results in paint lines that are not precisely straight.

### SUMMARY

In one example, according to the teachings of the present disclosure, a tape cutting tool includes a body, a first contact surface on the body, a second contact surface on the body oriented so as not to be parallel with the first contact surface, and a cutting blade held by the body. The cutting blade protrudes from the second contact surface and is spaced at a predetermined distance from the first contact surface.

In one example, the tape cutting can include an indexing device disposed to position the cutting blade in at least a first position protruding from the body relative to the second contact surface at a predetermined first distance.

In one example, the tape cutting toll can include an indexing device that can be selectively configured to selectively position the cutting blade in a second position protruding from the body at a predetermined second distance, different from the predetermined first distance.

In one example, the tape cutting tool can include an indexing device that can have a reversible protrusion configured to engage a slot on the cutting blade to selectively position the cutting blade.

In one example, the tape cutting tool can include an indexing device that can be configurable to selectively adjust the predetermined position of the cutting blade relative to the first contact surface or the second cutting surface.

In one example, the tape cutting tool can include an indexing device that can have a shim stack with a plurality of stackable and rearrangeable shims. The cutting blade can be disposed adjacent to any one of the shims or between any two of the shims to selectively adjust the predetermined position.

In one example, the tape cutting tool can include storage for one or more spare cutting blades within the body.

In one example, the tape cutting tool can include one or more spare cutting blades held within the body.

In one example, the tape cutting tool can include storage for one or more spare indexing devices within the body.

In one example, the tape cutting tool can include one or more spare indexing devices held within the body.

In one example, according to the teachings of the present disclosure, a tape cutting method includes applying tape to an object on both a surface to be painted and a surface not to be painted. The method also includes placing the first contact surface of the aforementioned tape cutting tools against a guide surface of the object. The method also includes moving the tool along the guide surface, cutting the tape with the cutting blade along a cut line. The method further includes removing a portion of the tape at the cut line to expose a surface to be painted adjacent to the tape left behind on the object.

### BRIEF DESCRIPTION OF THE DRAWINGS

The drawings provided herewith illustrate one or more examples or embodiments of the disclosure and therefore should not be considered as limiting the scope of the disclosure. There may be other examples and embodiments that may be equally effective to achieve the objectives and that may fall within the scope of the disclosure. Objects, features, and advantages of the present disclosure should become more apparent upon reading the following description in conjunction with the drawing figures, in which:

FIG. 1 shows a perspective view of one example of a tape cutting tool according to the teachings of the present disclosure.

FIG. 2 shows a side view of the tool of FIG. 1.

FIG. 3 shows a bottom, i.e., pressing side of the tool of FIG. 1.

FIG. 4 shows a top, i.e., working side of the tool of FIG. 1,

FIG. 5 shows a rear or grip end view of the tool of FIG. 1.

FIG. 6 shows a bottom, i.e., pressing side view of a first part of a body or housing of the tool of FIG. 1.

FIG. 7 shows an upper, i.e., working side view of the first part of the body of FIG. 6.

FIG. 8 shows a side view of the first part of the body of FIG. 6.

FIG. 9 shows a grip or rear end view of the first part of the body of FIG. 6.

FIG. 10 shows a top, i.e., working side view of a second part of the body or housing of the tool of FIG. 1.

FIG. 11 shows a lower, i.e., pressing side view of the second part of the body of FIG. 10.

FIG. 12 shows a rear or grip end view of the second part of the body of FIG. 10.

FIG. 13 shows a plan view of a cutting blade of the tool of FIG. 1.

FIG. 14 shows an end edge view of the cutting blade of FIG. 13.

FIG. 15 shows a side edge view of the cutting blade of FIG. 13.

FIG. 16 shows a side view of an indexing device of the tool of FIG. 1.

FIG. 17 shows an end view of the indexing device of FIG. 16.

FIG. 18 shows a top view of the indexing device of FIG. 16.

FIG. 19 shows a lengthwise cross-section of the tool of FIGS. 1-5.

FIG. 20 shows the upper or working side view of the first part of the body of FIG. 7, with the cutting blade of FIG. 13 in a first position defined by the indexing device.

FIG. 21 shows the first part of the body of FIG. 7, with the cutting blade in a second position, as depicted in FIG. 19 and different from the first position of FIG. 20, and defined by the indexing device.

FIG. 22 shows a top and rear perspective view of another example of a tape cutting tool according to the teachings of the present disclosure.

FIG. 23 shows a bottom and rear perspective view of the tape cutting tool of FIG. 22.

FIG. 24 shows a lengthwise cross-section of the tool of FIGS. 22-24.

FIG. 25 shows a top and front perspective view of the tape cutting tool of FIG. 22 and with a cutting blade in a selectable first position, as depicted in FIG. 24.

FIG. 26 shows the tape cutting tool of FIG. 25 but with the cutting blade in a selectable second position, different from the first position.

FIG. 27 shows an exploded view of the tape cutting tool of FIGS. 22-25.

FIG. 28 shows a lower, i.e., pressing side view of the second part of the body of the tape cutting tool of FIG. 27.

FIG. 29 is an exploded view of the tool of FIG. 1 and including a protective cover or sheath.

The use of the same reference numbers, element names, characters, etc. throughout the description and drawings indicates similar or identical components, aspects, and features of the disclosure.

### DETAILED DESCRIPTION OF THE DISCLOSURE

An aspect of the present disclosure is to solve or improve upon one or more of the above-noted problems with prior known paint masking techniques and tools. According to the present disclosure, a tape cutting tool is provided for achieving straight paint tape masking lines easily and quickly. The disclosed tape cutting tool, i.e., “the tool” is used to cut or trim painter's or masking tape to create a precise, consistent, and straight tape line. In one example, the tool is specifically designed for use in easily and precisely masking off and trimming painter's tape for painting the front facing cabinet edges on frameless cabinets.

The disclosed tape cutting tool is a precision cutting tool designed to significantly reduce the time, labor, and inconsistency involved in manually applying masking or painter's tape to the interior edge of European style, i.e., frameless cabinet boxes. This tape application procedure is traditionally a tedious and time-consuming process that requires a high degree of precision to ensure a clean and straight paint line and a professional finish.

The present disclosure addresses this need by providing a tape cutting tool that cuts the masking or painter's tape in a straight, consistent tape line or edge that is parallel to the leading edges of a cabinet box. The tape line can be cut so as to be at a precise distance, such as 0.5-2.0 millimeters, from the face of the cabinet box. The offset may vary by model, and the tool can be designed to provide a specific tape edge offset, if desired. The tool ensures uniform coverage and alignment, reduces prep time, and increases quality and repeatability in finishing applications.

In the disclosed embodiments, the tool has a body or housing with a size and shape that are depicted in the drawings. The size and shape depicted are merely to show aspects and features of the tool. The disclosed tool offers solutions to the above-noted problems by providing a guide function that uses a surface of the object to be painted as a guide to maintain a straight line while cutting tape. The tool allows the tape to be installed quickly and imprecisely, and then to be cut using the tool to create the precise and straight paint masking line. For each of the disclosed embodiments, the size, shape, materials, and/or other features and characteristics of the various components may be varied based on desired aesthetics, application or environment requirements, and other aspects for a given application.

The specification does not necessarily describe all elements of various embodiments of the present disclosure. Descriptions of elements or components well-known in the art to which the present disclosure pertains, or overlapping or repetitive descriptions, may have been omitted.

It should be understood that, when an element is referred to as being “connected” or “coupled” to another element, it can be directly or indirectly connected to the other element. An indirect connection includes one or more intervening elements or parts among or between two connected elements.

It should be understood that the terms “include,” “comprise”, “have,” and the like, and variations thereof, when used in the present disclosure, specify the presence of stated features, integers, steps, operations, elements, and/or components. The terms do not preclude the presence or addition of one or more other features, integers, steps, operations, elements, components, and/or groups thereof.

It should be understood that, where it is stated in the present disclosure that an element is located “on” another element, the element may be in direct contact with the other element or, alternatively, yet another element may be present between the one element “on” the other element.

It should be understood that, although the terms first, second, etc., and other such similar terms may be used herein to describe various elements, these elements should not be limited by these terms. These types of terms are used merely to distinguish among various elements, unless expressly stated to the contrary. Similarly, the terms “top,” “up,” “upward,” “bottom,” “down,” “downward,” “front,” “forward,” “back,” “rear,” “rearward,” and the like are used for reference as relative directional terms. It should be understood that these terms are also not strictly limiting, unless expressly stated herein.

It should be understood that the use of singular forms is intended to include the plural forms as well unless the context clearly dictates otherwise. Further, when a component, device, element, or the like of the present disclosure is described as having a purpose or performing an operation, function, or the like, the component, device, or element should be considered herein as being “configured to” meet that purpose or perform that operation or function.

Reference numerals, which may be used for method steps, are used for convenience of explanation, but not to limit an order of the steps. Thus, unless the context clearly dictates otherwise, the written order may be practiced otherwise.

Hereinafter, an operation principle and embodiments of the present disclosure are described in detail with reference to the accompanying drawings. In each example, the tool has a body or housing and a cutting blade placed precisely relative to a guide portion of the body or housing. In each example, the cutting blade is adjustable relative to the body or housing among at least two different selectable positions. However, in other examples, the blade may be non-adjustable and instead may be provided in a precise, fixed position designed only for a specific application or use. In other examples, the different cutting blade adjustment features described below may be provided in the same tool instead of in different tools. The present disclosure is for a tool configured for precisely cut paint masking tape applied to European style frameless cabinets. However, as should be apparent to those having ordinary skill in the art, the tape cutting tool may be configured to be used for other precision paint tape cutting applications as well.

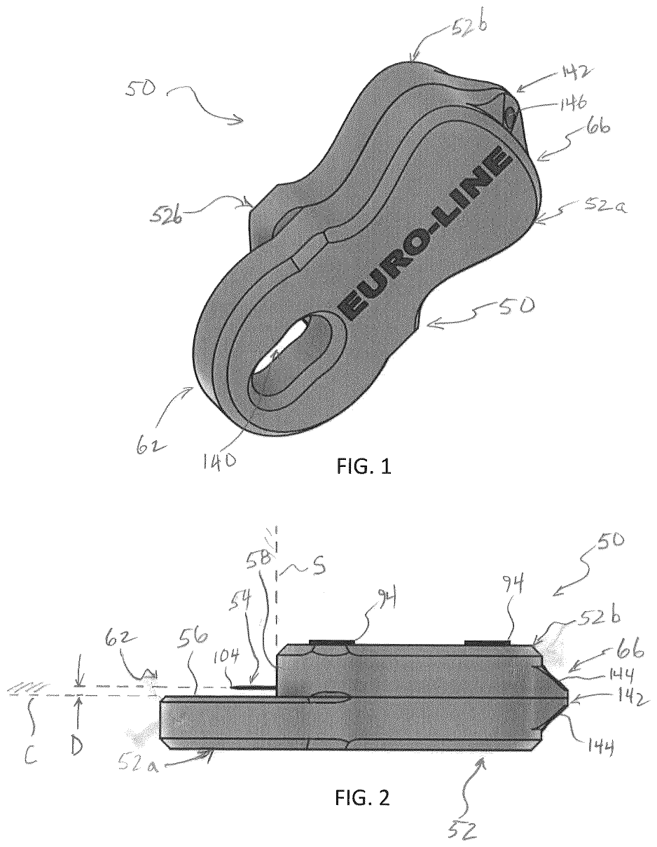

One example of a tape cutting tool, i.e., a tool 50 according to the teachings of the present disclosure is shown in FIGS. 1-5. The tool 50 may include any one or more of the following features and may include such features in any combination thereof. In general, the tool 50 has a housing or body, i.e., a body 52 that holds a cutting blade 54. The body 52 defines a first contact surface 56 and a second contact surface 58. The first contact surface 56 is configured and arranged to bear against a surface of an object that is taped or masked off to be painted. The cutting blade 54 is precisely positioned by the configuration of the body 52 at a predetermined distance or a selected distance relative to the first contact surface 56. The cutting blade 54 may be arranged and held parallel to the first contact surface 54. The second contact surface 58 may be perpendicular to the first contact surface 56 and the cutting blade 54. The cutting blade 54 may protrude from or relative to the second contact surface 58 and may protrude a predetermined length or a selected length beyond and relative to the second contact surface 58.

Referring to FIGS. 1, 2, and 5, the body 52 in one example may have two separable parts including a bottom part 52a and a top part 52b. As shown in FIGS. 6-9, in this example, the bottom part 52a, i.e., a first part of the body 52 has an end wall or end surface, i.e., end wall 60 on a working end 62, i.e., a forward or first end of the body. The first part 52a of the body 52 also has an opposite end wall or end surface, i.e., end wall 64 on a grip end 66, i.e., a rear or second end of the body. The first part 52a further has a bottom wall or bottom surface; i.e., bottom wall 68 on a pressing side of the tool, an opposite upper wall or upper surface, i.e., upper wall 70, and opposed side walls or side surfaces, i.e., sides 72 that connect and extend between the bottom wall 68 and upper wall 70 and that join with or connect to the end walls 60, 64. The sides 72 and end walls 60, 64 together define an outer perimeter wall or surface of the first part 52a. The first part 52a may be mostly a solid body or may be mostly or partly hollow. Thus, the terms “wall” or “surface” in this context are meant to refer to the corresponding outer facing surfaces and not necessarily to limit the structure of the first part 52a to being hollow, solid, or a combination thereof.

Referring to FIGS. 10-12, in this example, the top part 52b, i.e., a second part of the body 52 has an end wall or end surface, i.e., end wall 80 on the working end 62 of the body. The second part 52b of the body also has an opposite end wall or end surface, i.e., end wall 82 on the grip end 66 of the body. The second part 52b further has a lower wall or lower surface, i.e., lower wall 84, an opposite top wall or top surface, i.e., top wall 86, on a working side of the tool, and opposed side walls or side surfaces, i.e., sides 88 that connect and extend between the top wall 86 and lower wall 84 and that join with or connect to the end walls 80, 82. The side 88 and end walls 80, 82 together define an outer perimeter wall or surface of the second part 52b. The second part 52b may also be mostly a solid body part or may be mostly or partly hollow. Thus, the terms “wall” or “surface” in this context are again meant to refer to the corresponding outer facing surfaces and not necessarily to limit the structure of the second part 52b to being hollow, solid, or a combination thereof.

When the tool 50 is fully assembled, the upper wall 70 of the first part 52a faces and at least partly confronts or abuts the lower wall 84 of the second part 52b. In this example, the second part 52b is shorter in length between its ends 80, 82 than the length of the first part 52a between its ends 60, 64. Thus, a portion of the upper wall 70 of the first part 52a is exposed and defines the first contact surface 56 of the tool 50.

The first part 52a and second part 52b can be fastened or otherwise snapped or secured together to form the body 52. In this example, the second part 52b includes one or more through holes 90 and the first part 52a includes complementary through holes or blind holes 92. The upper wall 70 of the first part 52a and the lower wall 84 of the second part 52b are positioned facing or in contact with one another. The corresponding holes 90 and 92 are aligned to receive fasteners. In one example, the holes or blind holes 92 may be threaded and configured to receive mechanically threaded screws 94 (see FIGS. 2, 4, and 5) to secure the two parts together. As noted below, the screws 94 or other body-securing features may be configured to permit the body to be disassembled to access the cutting blade 54 and other components within the body 52.

In one example, the body 52 of the tool 50 may be a lightweight, handheld rigid structure that forms guide features via the contact surfaces 56 and 58, as discussed below. The body 52 can be sized to fit in one hand of a user. The sides 72, 88 and ends 60, 64, 80, 82, and/or other walls or surfaces of the body 52, can be configured to define contoured shapes designed to provide ergonomic gripping surfaces or areas on the body. However, the size and shape of the tool 50, and the body 52 in particular, may vary considerably while remaining within the scope of the present disclosure. The material or materials used to form the body 52 can vary and may include or be selected from a variety of metals, plastics, composites, various material combinations, or the like. The material or materials used to fabricate the tool 50, and the body 52 in particular, may also vary considerably while remaining within the scope of the present disclosure. The screws 94 may be replaced by other securing features such as snaps, clips, one or more hinges, or other releasable fastening devices or mechanisms as desired.

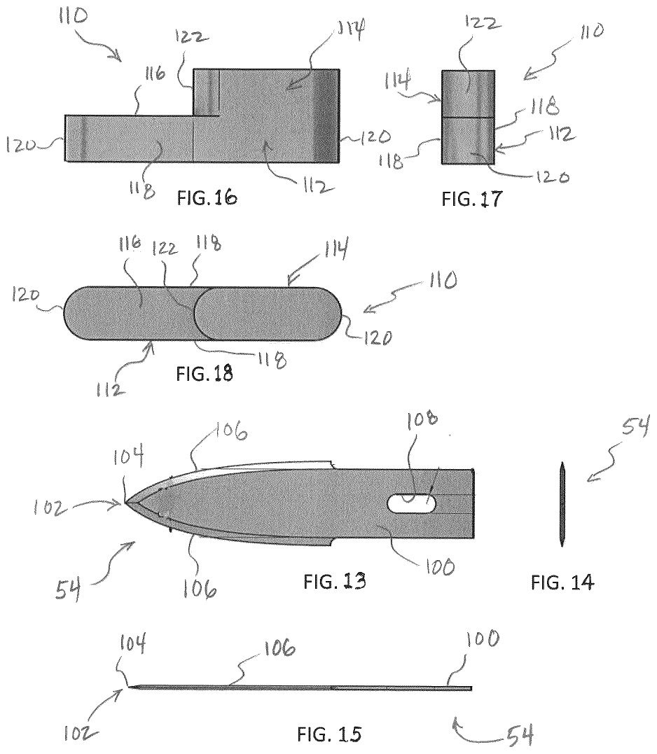

In one example, with reference to FIGS. 13-15, the cutting blade 54 may include a proximal end or stem 100 and a distal or cutting end 102. When installed for use, the stem 100 is oriented toward the grip end 66 of the body 52 and the cutting end 102 is oriented toward the working end 62 of the body. The cutting tip 102 of the blade 54 may have a sharp point 104 and tapered, sharp, cutting edges 106 that extend from the point 104 along each side edge of the cutting tip 102. In one example, the cutting blade 54 of the tool 50 may be in the form of a double-edged, carbon steel scalpel-style blade for optimal cutting and for cutting in two directions via the sharp point 104 and the two cutting edges 106.

In one example, the cutting blade 54 also has an elongate slot 108 disposed toward the proximal end on the stem 100. As discussed below, the slot 108 is provided for retaining the cutting blade in position relative to the body 52 when installed. Also, in this example, the slot 108 is used for selectively changing and repositioning the cutting blade 54 relative to the body 52 among at least two different positions.

In some examples, the tool 50 may be adjustable to provide at least two different blade positions for the cutting blade 54. The cutting blade 54 may be moved within or relative to the body 52 and relative to one, the other, or both of the contact surfaces 56, 58. In one disclosed example, with reference to FIGS. 16-18, the tool 50 may be provided with an indexing device 110. The indexing device 110 is configured to position and retain the cutting blade 54 in one of two lengthwise adjustable positions in this example. The indexing device 110 has a base portion 112 with an elongate oval cylinder shape. An indexing portion or protrusion 114 extends from a top surface 116 of the base portion 112. The base portion 112 has elongate flat sides 118, curved ends 120 and a length between the curved ends. The protrusion 114 commonly terminates at one of the curved ends 120 of the base portion 112. The protrusion 114 may be about half the length of the base portion 112 and thus terminates at its other end at a different curved end 122.

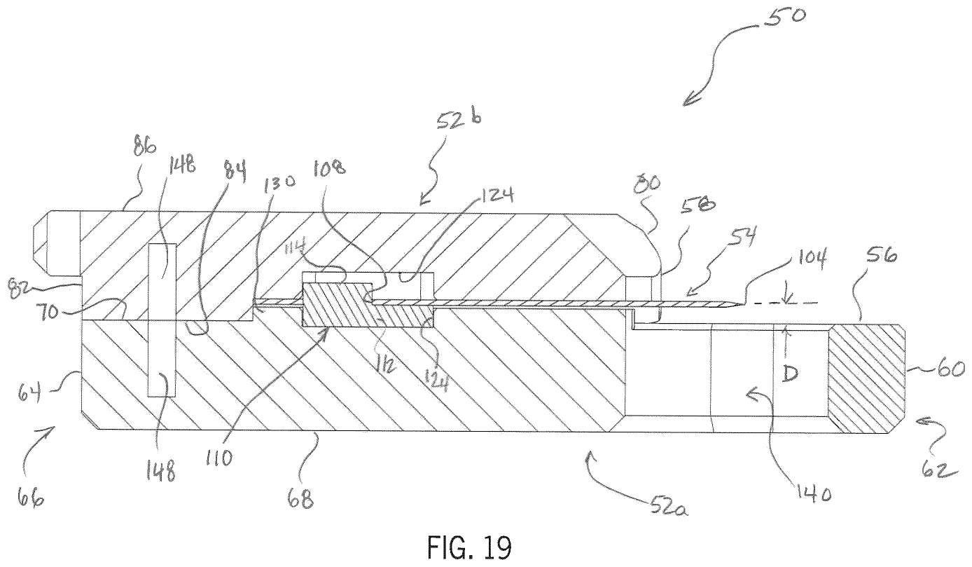

In this example, with reference to FIGS. 19-21, the shape of the protrusion 114 matches the shape of the slot 108 in the cutting blade 54. Likewise, the protrusion 114 and slot 108 are also sized so that the protrusion closely fits within the slot 108. Though the slot 108 and protrusion 114 are elongate oval shapes in this example, the shapes, though complementary with one another, may vary and yet function as intended. Having these shapes be something other than round or circular prevents rotation of the cutting blade relative to the indexing device and thus the body when installed.

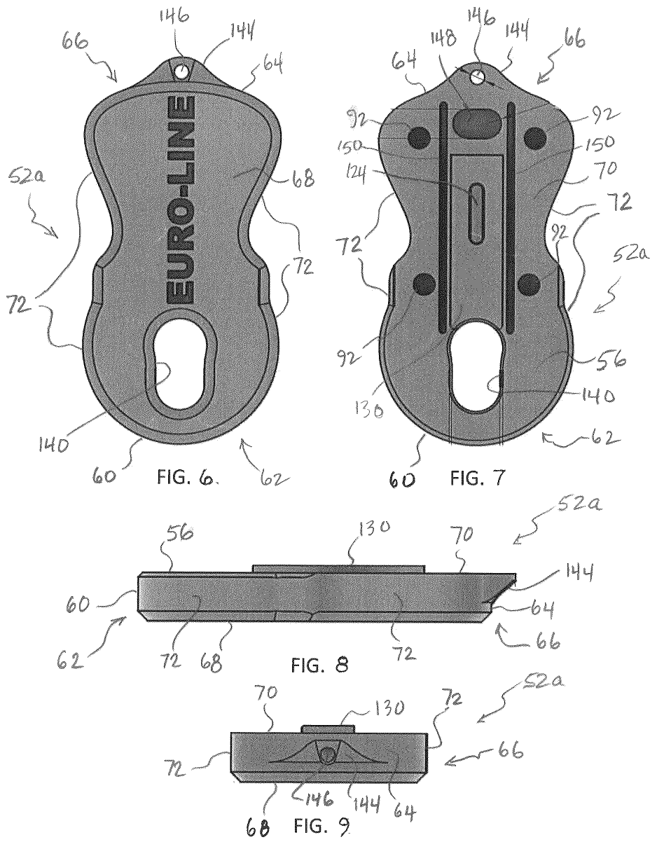

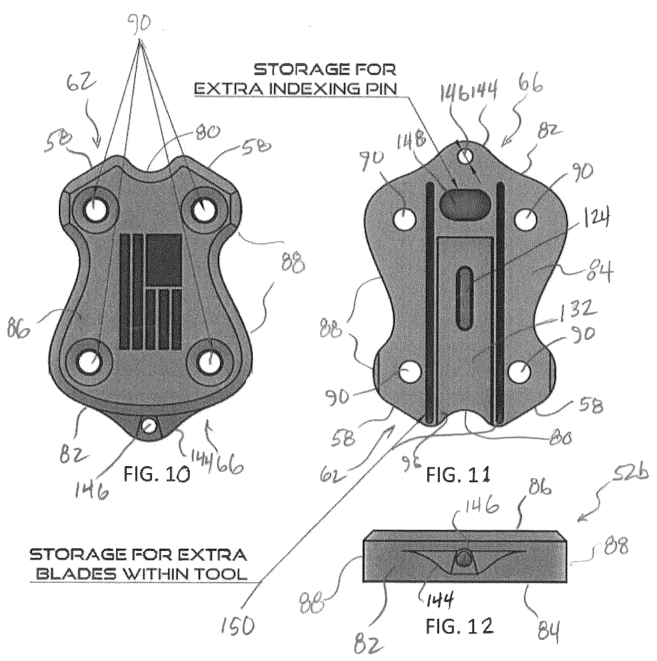

The base portion 112 of the indexing device 110 can be seated in an oval or elongate recessed slot, i.e., recess 124, which may be provided in either part of the body 52. In this example, the first part 52a of the body 52 has a raised blade support or pad 130 on the upper wall 70, as shown in FIGS. 7-9. The height of the support 114 may be set to position the cutting blade 54 at a predetermined specific distance D from the first contact surface 56 (see FIG. 2), which is defined on the exposed portion of the upper wall 70 on the first part 52a of the body 52. The lower wall 84 of the second part 52b has a corresponding recessed channel 132 (see FIG. 11) configured and arranged to fit both the support or pad 130 and the cutting blade 54 when the body 52 is assembled. The channel 132 has an opening 96 at one end through which the cutting blade 54 can protrude from the body 52. A recess 124 or blind slot may be provided in the upper wall 70 on the first part 52a coincident with the support or pad 130 and/or may also be provided on the lower wall 84 coincident with the channel 132. The shape of the recesses or blind slots 124 match the shape of the base portion 112 of the indexing device 110. Likewise, the recess 124 in the first part 52a and base portion 112 are also sized so that the base portion closely fits within that recess 124. Though the recesses or blind slots 124 and the base portion 112 and protrusion 114 are elongate oval shapes in this example, the shapes, though complementary with one another, may vary and yet function as intended. Having these shapes be something other than round or circular prevents rotation of the indexing device relative to the body when installed.

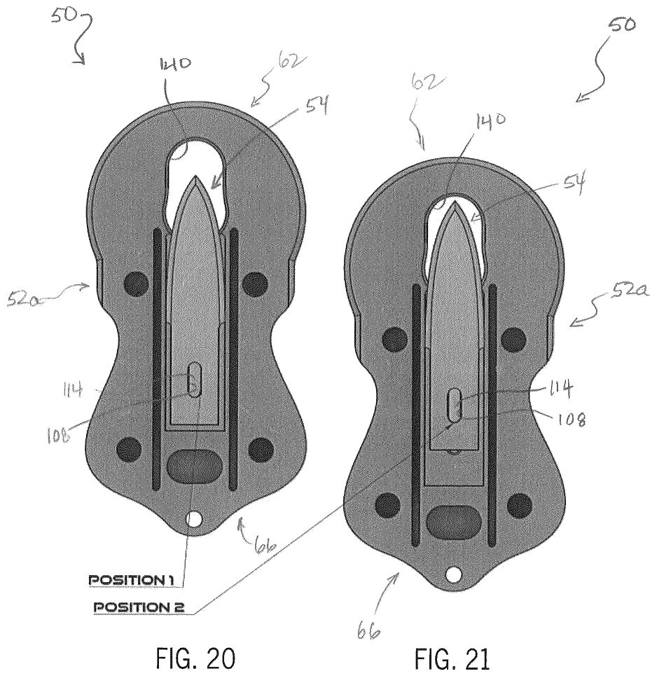

The lengthwise position of the cutting blade 54 can be adjusted by reversing the orientation of the indexing device 110 within the recesses 124. This changes the position of the protrusion 114 from one end of the recesses 124 to the other, which changes the position of the slot 108 and thus the cutting blade 54. In this example, the position of the cutting blade 54 is effectively retracted (first position, FIG. 20) or extended (second position, FIG. 21) relative to the second contact surface 58 on the body 52, while remaining at the same distance D relative to the first contact surface 56 of the body.

In one example, the cutting blade 54 may be positioned in a first selectable position, such as a standard material position, depending on the material thickness of the cabinet. In one example, the first position may be the more retracted position of FIG. 19, with the protrusion 114 disposed closer to the grip end of the body 52, to accommodate a thicker or standard cabinet material thickness, such as a ¾″ material. In one example, the cutting blade 54 may be positioned in a second selectable position, such as a reduced material position. In one example, the second position may be the extended position of FIG. 20, with the protrusion 114 disposed further from the grip end of the body, to accommodate a thinner or reduced cabinet material thickness, such as ½″ to ⅝″ material.

The tool 50 may also be provided with other features as well. In one example, the tool 50 may include a viewing window 140 through the first part 52a at the working end 62 of the body 52 for a user to view the point of contact of the cutting blade 54 with the cabinet surface and/or tape to ensure accurate positioning. See FIGS. 1, 6, 7, 19, and 20. The viewing window 140 may also be used to assist a user in applying precise pressure against the cabinet with an index finger for achieving a precision cut.

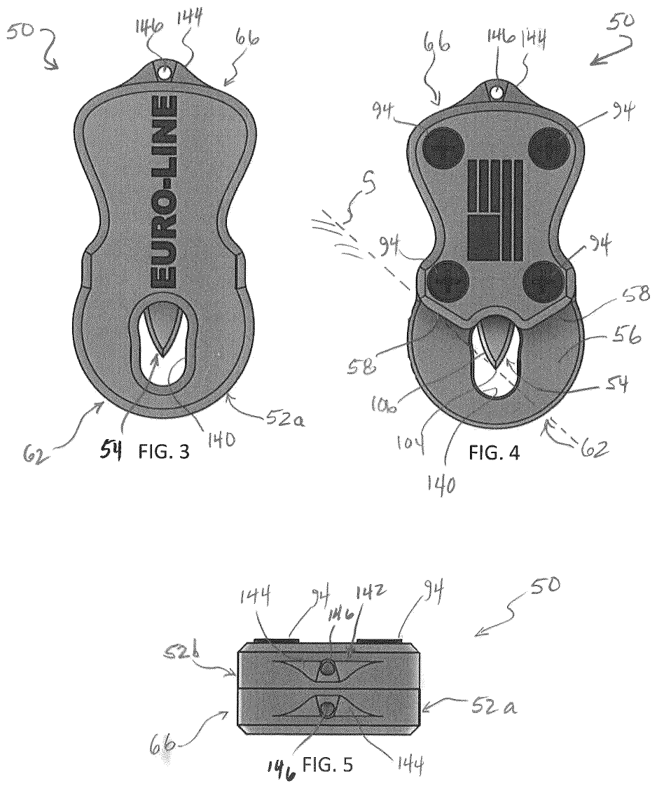

In one example, the tool 50 may have an additional access or attachment point 142 at the rear or grip end 66 of the body 52. In one example, each of the parts 52a and 52b may include a boss 144 protruding from the respective end walls 64, 82 at the grip end 66 of the body. Each boss 144 may include a hole 146 that are aligned with one another on the tool 50. A lanyard or loop (not shown) may be received through the holes 146 in the bosses 144 for convenient storage and access. See FIGS. 3-12.

In one example, the tool 50 may be configured to accommodate holding or storing a spare indexing device 110 or an indexing device that provides different selectable blade positions. In one example, such a spare indexing device may be stored in a receptable 148 provided in one or both of the upper wall 70 of the first part 52a and the lower wall 84 of the second part 52b of the body 52, as shown in FIGS. 7, 11, and 19. In one example, the tool 50 may also be configured to include a storage space 150 or spaces within the body 52 for spare or additional cutting blades. In one example, two such spare cutting blades may be stored in pairs of narrow slots as the storage spaces 150. As shown in FIGS. 7 and 11, the narrow slots or spaces 150 may also be provided in one or both of the upper wall 70 of the first part 52a and the lower wall 84 of the second part 52b of the body 52, with each extending lengthwise on opposite sides of the pad 130 and the blade channel 132. The narrow slots or spaces 150 in one example are long enough and deep enough to fully accommodate one of the cutting blades 54. In other examples, the body 52 may include one or more storage cavities to store spare blades and/or indexing devices.

In one example, the body 52 may be configured so that the guides or contact surfaces 56, 58 are located and oriented to position the cutting blade 54 correctly, i.e., at a desired, selected, or predetermined position and to hold the correct position during use. In one example, the cutting blade 54 may not be adjustable, such as in a simple, single position designed tool 50. In other examples, the cutting blade 54 may be positionally adjusted, which effectively changes the relationship between the cutting blade and either one or both of the contact surfaces 56, 58.

The second contact surface 58 may be configured to bear against the taped surface S of the object with the body 52 held at an angle to the surface, as depicted in FIGS. 2 and 4. Thus, the first contact surface 56 of the body 52 may be pressed against and moved along a surface of the taped object, such as a cabinet surface C, as depicted in FIG. 2. The second contact surface 58 can be borne and held against the taped surface. The body 52 can be tilted so that the cutting blade 54 contacts the tape as the tool 50 can be moved along the object surface. As shown in FIG. 4, the second contact surface 58 on either side of the cutting blade 54 can be curved or angled accordingly. The second contact surface 58 may be eliminated or may not be utilized, and the cutting blade 54 may simply be placed in contact with the tape to be cut. The object surface can guide the tool 50 in a manner such that the cutting blade 54 cuts the tape in a straight line, leaving a tape edge with a precise and consistent gap to the object surface to be painted. Thus, the tool 50 aids in cutting the tape using a surface C of the object to be painted as a guide.

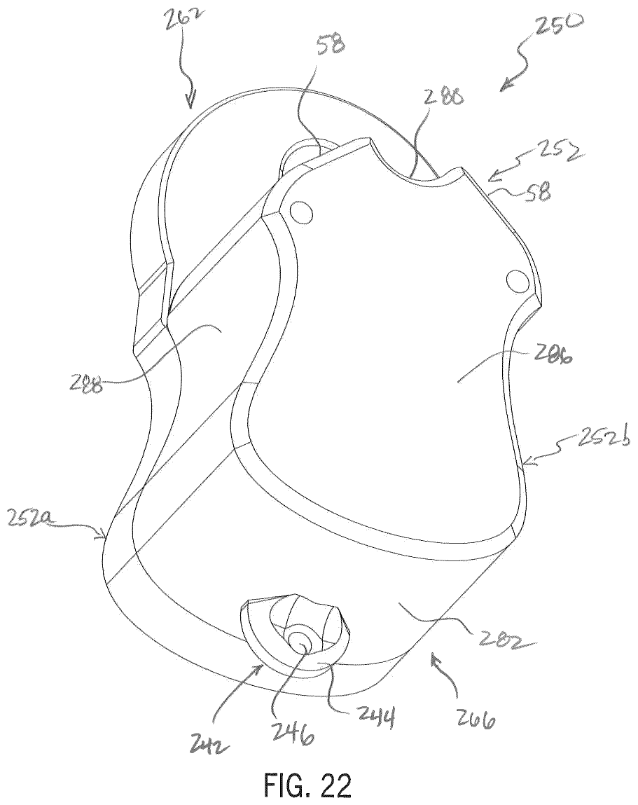

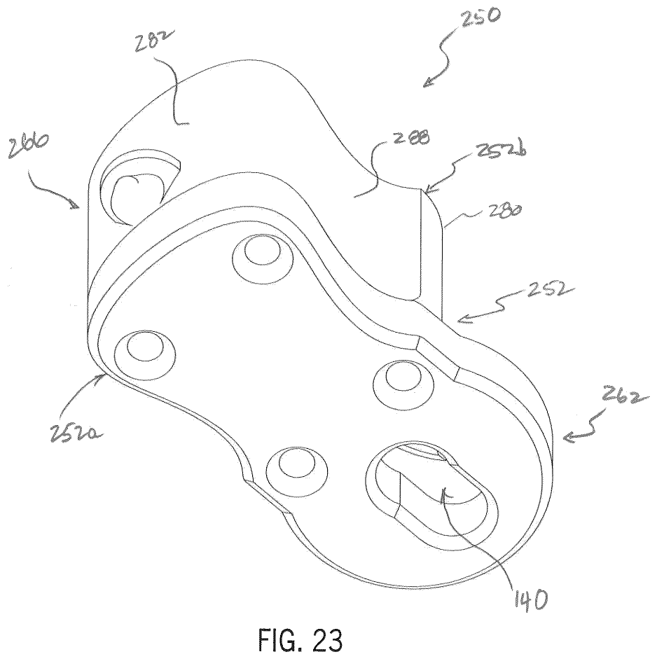

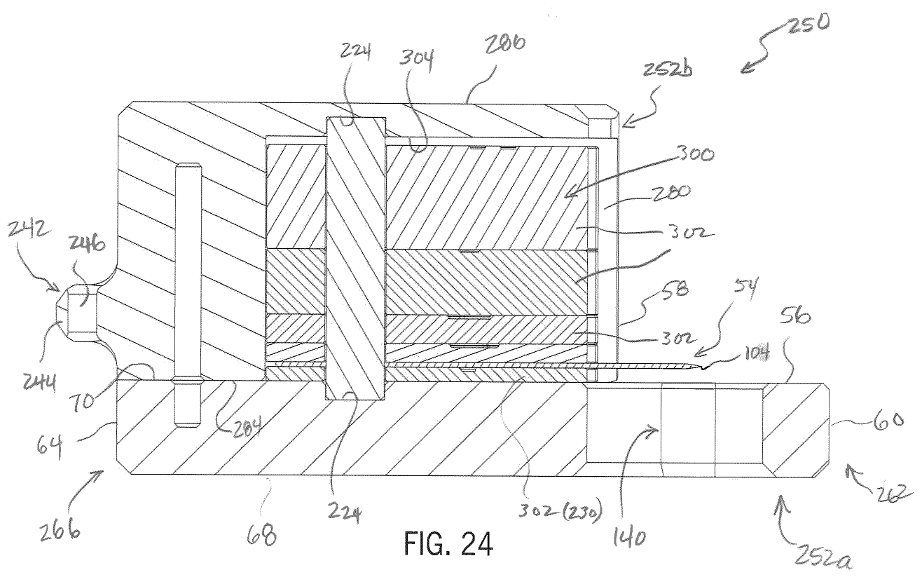

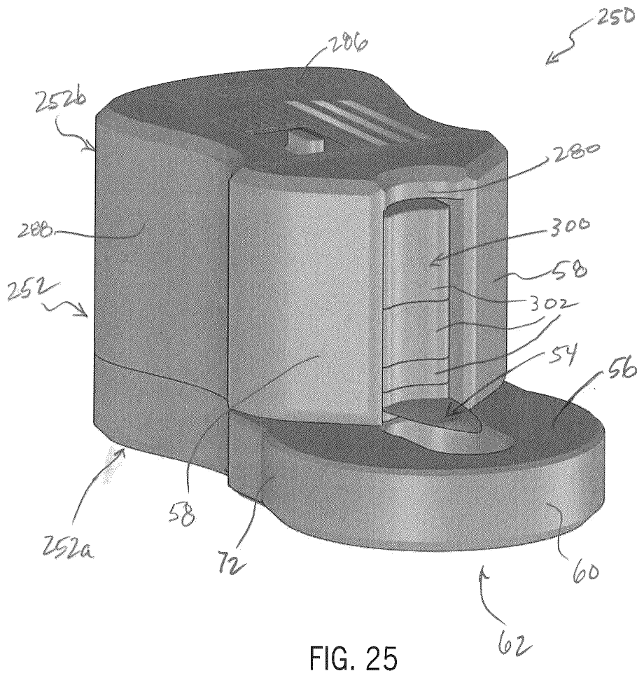

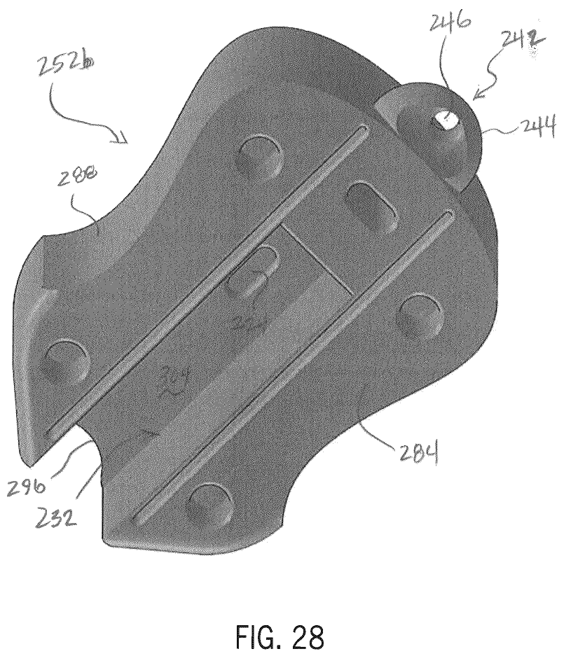

FIGS. 22-28 show another embodiment of a tool 250 in accordance with the teachings of the present disclosure. The tool 250 may include any one or more of the foregoing or the following features and may include such features in any combination thereof. In this example, the tool 250 has a housing or body, i.e., a body 252 that holds a cutting blade 54. The body 252 defines the first contact surface 56 and the second contact surface 58 in the same manner as described above. The cutting blade 54 is precisely positioned by the configuration of the body 252 in this example at a selected distance relative to the first contact surface 56. The cutting blade 54 may again be arranged and held parallel to the first contact surface 56. The second contact surface 58 may again be perpendicular to the first contact surface 56 and the cutting blade 54. The cutting blade 54 may protrude from or relative to the second contact surface 58 and in this example may protrude a predetermined or fixed length beyond and relative to the second contact surface 58. The tool 250 may, however, include a length adjustable feature as described above for the tool 50. Likewise, the tool 50 may include a blade height adjustment feature as described below for the tool 250.

The body 252 in this example has two separable parts including a bottom part 252a and a top part 252b. In this example, the bottom part 252a, i.e., the first part, may have essentially the same configuration as the first part 52a of the body 52 as described above. In this example, the top part 252b, i.e., the second part of the body 252 has a modified construction to accommodate a blade height adjustment feature. In this example, the second part 252b has an end wall or end surface, i.e., end wall 280 on a working end 262 of the body. The second part 252b also has an opposite end wall or end surface, i.e., end wall 282 on a grip end 266 of the body 252. The second part 252b further has a lower wall or lower surface, i.e., lower wall 284, an opposite top wall or top surface, i.e., top wall 286, and opposed side walls or side surfaces, i.e., sides 288 that connect and extend between the top wall 286 and lower wall 284 and that join with or connect to the end walls 280, 282. The side 288 and end walls 280, 282 together define an outer perimeter wall or surface of the second part 252b. In this example, the sides 288 and end walls 280, 282 are taller than the tool 50.

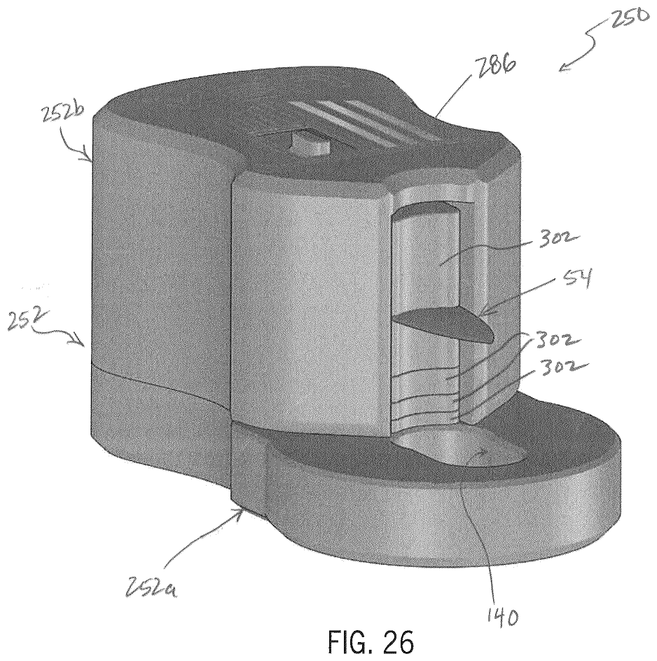

The lower wall 284 of the second part 252b has a recessed channel 232 (see FIG. 26) that is also taller in height compared to the channel 132 of the tool 50. The channel 232 has an elongate opening 296 at one end through which the cutting blade 54 can protrude from the body 252. The channel 232 is configured and arranged to fit the cutting blade 54 and an adjustable indexing device in the form of a shim stack 300 when the body 252 is assembled. A recess or blind slot 224 is provided in the upper wall 70 on the first part 252a coincident with an optional support or pad 230 or a shim 302 of the shim stack 300 for the cutting blade 54.

When the tool 250 is fully assembled, the upper wall 70 of the first part 252a faces and at least partly confronts or abuts the lower wall 284 of the second part 252b. In this example, the second part 252b is shorter in length between its end walls 280, 282 than the length of the first part 252a between its ends 60, 64. Thus, a portion of the upper wall 70 of the first part 252a is exposed and again defines the first contact surface 56 of the tool 250. The end wall 280 of the second part 252b again defines the second contact surface 58 in this example. The first part 252a and second part 252b can be fastened or otherwise snapped or secured together to form the body 252 in any suitable manner.

In this example, instead of a fixed blade height, the cutting blade 54 is adjustable in height, allowing a user to selectively change the distance D between the cutting blade and first contact surface 56. The above-noted indexing device, i.e., shim set 300 is configured to provide an adjustable offset mechanism. The shim stack 300 includes a plurality of the shims 302 or spacers of different thickness or height. The shims 302 are reconfigurable and interchangeable spacing elements that are stackable and positionable within the channel 232 between the upper wall 70 of first contact surface 56 of the first part 252a and the channel closure surface 304 within the channel 232. The cutting blade 54 can be placed under the shim stack 300 or between any two of the shims 302 to selectively change the position of the blade. In one example, each spacer or shim 302 corresponds to a predetermined thickness. Thus, installation of the cutting blade 54 at different positions along the shim stack 300 defines the offset distance D at which the tape is cut relative to the edge.

In one implementation, the shim stack 300 may include five discrete shims or spacers 302 having thicknesses of approximately 1 mm, 2 mm, 3 mm, 7 mm, and 11 mm. The spacers or shims 302 can be selectively arranged and stacked to provide a range of offset distances D in 1 mm incriminates between 1 mm and 25 mm. However, the number of shims or spacers may be varied, as can the incremental highest of the shims. For example, 25 shims of 1 mm each could also be provided for the shim stack 300 while producing the same 1 mm position increment outcome. Other variations are certainly possible and two or more of the shims in a shim stack may have the same thickness or different thicknesses. The spacers or shims 302 may be removably rearranged and stacked in different arrangements, thereby allowing a user to customize the offset distance D based on application requirements.

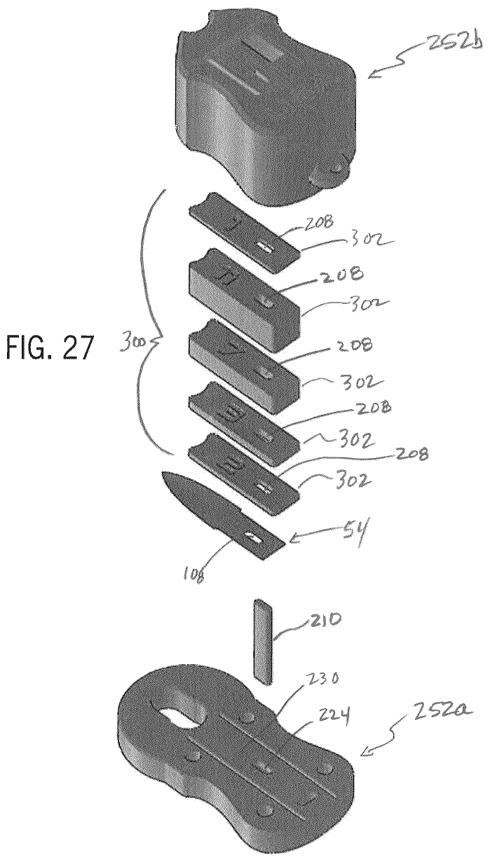

As shown in FIG. 27, an indexing bar 210 of the indexing device or shim stack 300 can be provided having a length sufficient to penetrate the cutting blade and the entire shim stack 300. Likewise, the shims 302 and the cutting blade 54 can each have a slot 208 sized to allow the indexing bar 210 to pass. The slots 208 and the cross-section shape of the indexing bar 210 should be complementary, similar to the protrusion 114 of the indexing device 110 and the slot 108 as described above. The ends of the indexing bar 210 can be received in blind recesses 224 in both the upper wall 70 on the first part 252a and the channel surface 304 to retain the shim stack and cutting blade 54 in place within the assembled tool 250.

In one example, the tool 250 may have an additional access or attachment point 242 at the rear or grip end 66 of the body 252. In one example, only the second part 252b may include a boss 244 protruding from the respective end wall 82 at the grip end 66 of the body. The boss 244 may include a hole 246 for lanyard or loop (not shown) that may be received through the hole 246 in the boss 244 for convenient storage and access. See FIGS. 22-24 and 28.

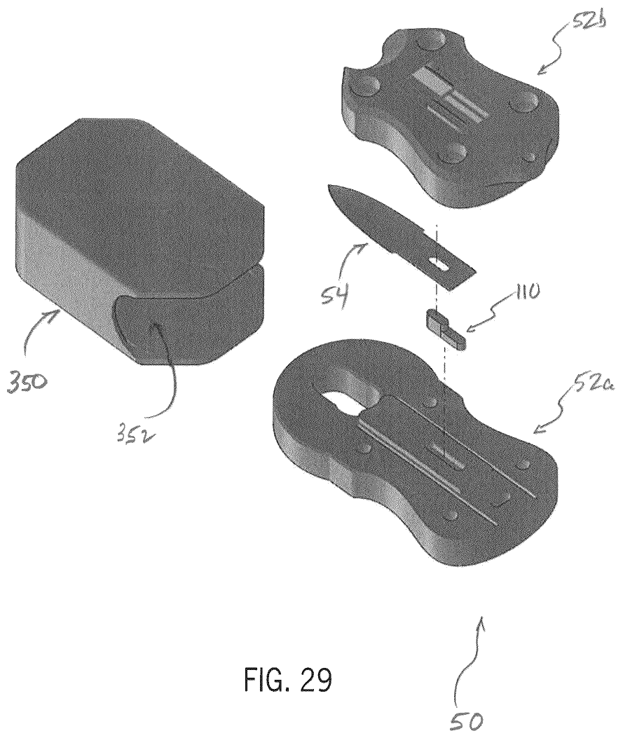

FIG. 29 shows an exploded view of the tool 50 to aid in understanding the construction of the tool. Also, each tool 50 and 250 can include a corresponding sheath for stowing the tool and covering and protecting the cutting blade 54. In one example, a sheath 350 is configured to accommodate the tool 50 and can define a cavity 352 into which all or part of the body 52 of the tool 50 can be received and stowed. See FIG. 27.

The tools 50 and 250 in the disclosed examples are designed specifically for frameless or European-style cabinetry. However, the tools 50, 250 may be used for other applications as needed. The shape of the body may also be altered to better accommodate other applications as well as to provide different aesthetic appearances, grips, or the like.

The disclosed tape cutting tools offer a number of advantages and benefits. For example, the tools significantly reduce masking time. The tools also deliver consistently clean paint lines. The tools also reduce tape waste and rework caused by tape misalignment. The tools are easy to use, even for less experienced workers. The tools also enhance quality and professionalism in finishing work. The tools also include storage space within the tools for additional parts.

The intended use and application for the disclosed tape cutting tools are described below. The tools are intended for use by professional painters, cabinet refinishers, furniture makers, and do-it-yourself enthusiasts working with frameless cabinetry or other objects to be taped and painted. The tools are suitable for both new construction and renovation projects.

To use the disclosed tools, the user first lays down the tape on the inside/front edge of the cabinet. The tape may overhang the front of the cabinet by up to about ⅛″. The excess tape is then folded onto the face edges of the cabinet. Thus, precise placement and alignment of the tape is not necessary. For a clean corner, a “painters 5-in-1” tool may be used to push tape tightly into the corner of the cabinet and then the tape is folded over the cabinet face at the corner. Starting in the corner of the cabinet, the tool may be held with the thumb and middle finger. The blade is placed to the corner of the cabinet. Ample, consistent pressure may then be applied with the index finger in the viewing window of the housing or body while sliding the tool in a smooth, flowing manner, with the blade contacting the tape on the interior surface of the cabinet, along the object surface. This creates a clean cut of the tape. This process is then repeated in each opposite corner to connect the cuts. When done cutting, the user may simply peel the tape off the face edges of the cabinet to reveal a consistent and repeatable tape line.

Although certain tape cutting tools have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A tape cutting tool comprising:
a body;
a first contact surface on the body;
a second contact surface on the body oriented so as not to be parallel with the first contact surface; and
a cutting blade held by the body,
wherein the cutting blade protrudes from the second contact surface and is spaced at a predetermined distance from the first contact surface.

2. The tape cutting tool of claim 1, further comprising:
an indexing device disposed to position the cutting blade in at least a first position protruding from the body relative to the second contact surface at a predetermined first distance.

3. The tape cutting tool of claim 2, wherein the indexing device is selectively configurable to selectively position the cutting blade in a second position protruding from the body at a predetermined second distance, different from the predetermined first distance.

4. The tape cutting tool of claim 3, wherein the indexing device includes a reversible protrusion configured to engage a slot on the cutting blade to selectively position the cutting blade.

5. The tape cutting tool of claim 2, wherein the indexing device is configurable to selectively adjust the predetermined position of the cutting blade relative to the first contact surface or the second cutting surface.

6. The tape cutting tool of claim 5, wherein the indexing device includes a shim stack having a plurality of stackable and rearrangeable shims, and wherein the cutting blade can be disposed adjacent any one of the shims or between any two of the shims to selectively adjust the predetermined position.

7. The tape cutting tool of claim 1, further comprising storage for one or more spare cutting blades within the body.

8. The tape cutting tool of claim 1, further comprising one or more spare cutting blades held within the body.

9. The tape cutting tool of claim 1, further comprising storage for one or more spare indexing devices within the body.

10. The tape cutting tool of claim 1, further comprising one or more spare indexing devices held within the body.

11. A tape cutting method comprising:
applying tape to an object on both a surface to be painted and a surface not to be painted;
placing the first contact surface of the tool according to claim 1 against a guide surface of the object;
moving the tool along the guide surface, cutting the tape with the cutting blade along a cut line; and
removing a portion of the tape at the cut line to expose a surface to be painted adjacent the tape left behind on the object.
